(19) United States
(12) Patent Application Publication
(10) Pub. No.: US 2003/0167262 A1
(43) Pub. Date: Sep. 4, 2003

(54) Cross-search method and cross-search program

(75) Inventors: Kazue Iida, Shizuoka (JP); Yoriko Sato, Shizuoka (JP); Yasuhiro Watanabe, Kawasaki (JP); Yukiko Tai, Kawasaki (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 10/358,156

(22) Filed: Feb. 5, 2003

(30) Foreign Application Priority Data
Feb. 7, 2002 (JP) 2002-031009

(51) Int. Cl. G06F 7/00

(52) U.S. Cl. 707/3

(57) ABSTRACT

A cross-search CGI program executes a group of functions defined in a script definition for a selected search site with respect to a search condition contained in a search request message received from a Browser, and generates a search condition based on a description rule available by the search site. The cross-search CGI program sends a search request message with this search condition used as an argument to the search site 3. When receiving HTML data of a search result from this search site, the cross-search CGI program executes the group of functions defined in the same script definition, thereby converting the HTML data of the search result and transmitting screen data of a search result display screen containing the HTML data after being converted as a response to the Browser.

### BACKGROUND OF THE INVENTION

1. Field of the Invention

The present invention relates to a cross-search method of requesting any one of a plurality of information search sites existing on a network for an information search based on a search condition designated by a user, and displaying a result of the information search to the user, and to a cross-search program for making a computer execute this cross-search method.

2. Description of the Prior Art

Various categories of information search sites (such as an electronic library system, a database search site, a Web search site and so forth) are structured on a network such as the Internet etc., and hence users having their own terminals connectable to the network are able to obtain necessary items of information by arbitrarily accessing those search sites.

Each of those information search sites is, in the great majority of cases, structured independently of other information search sites. Even if a certain information search site is administered in cooperation with other search sites, this cooperation is no better than a cooperation to such an extent that those search sites are linked to each other. Accordingly, the user must, if unable to find out the necessary item of information on a certain single search site, repeat steps of accessing again other search site and making an information search request.

Further, each information search site has a unique search condition input system (a structure of a search input screen, a scheme containing or not containing a logic operator available for a search algorithm (expression), a type of the logic operator, and so on), and has a unique way of setting parameter names assigned to respective search items when taking an inputted search condition into the search algorithm. Hence, the description rule for the search condition is not yet normalized among the respective information search sites. Moreover, communication protocols utilized by the respective search sites are not yet unified, wherein there exist the search sites utilizing Z39.50 search protocol other than the search sites utilizing HTTP (HyperText Transfer Protocol). Accordingly, whenever accessing the individual information search site, each user needs to perform data communications with the information search site with switching over the communication protocol of the terminal to a communication protocol available by the information search site concerned and to input a search condition based on an input method designated by the information search site.

Thus, there exists no mechanism for the user to obtain the necessary items of information by requesting a plurality of information search sites to execute the information search.

### SUMMARY OF THE INVENTION

It is a primary object of the present invention to provide a cross-search method for generating a search condition based on a description rule for a search condition used by an information search site and a search condition once inputted by a user in accordance with a predetermined format and for requesting the information search site with designating the generated search condition, and a cross-search program for implementing this cross-search method by use of a computer connectable to a network.

A cross-search method in accordance with the present invention is for performing communications with a plurality of information search sites via a network, requesting each of said for an information search, and receiving a search result of the information search. The cross-search method has a step of preparing beforehand, for each of said information search sites, a script that defines definitions of functions for converting a predetermined description rule for a search condition into a description rule used by said information search site, a step of specifying said information search site designated by a user, a step of acquiring the search condition designated by the user on the basis of the predetermined description rule, a step of converting the search condition into a search condition based on the description rule used by said information search site by executing the function defined in said script corresponding to said information search site specified in said information search site specifying step with respect to the search condition acquired in said search condition acquisition step, a step of sending, to said information search site, an information search request based on the search condition converted in said search condition converting step, a step of receiving a search result of the information search conducted under the search condition by said information search site in response to the information search request, and a step of displaying the search result received in said search result receiving step to the user.

Thus constructed, a search condition specifying a condition of the search requested by the user is acquired based on the predetermined description rule. This description rule defines a description rule for a certain single category of search condition. When the user designates one or a plurality of information search sites from which the search is requested, a script corresponding to the information search site is read for every designated information search site. Then, a conversion function defined in this script is executed with respect to the search condition acquired from the user, thereby generating a specific search condition based on the description rule for the search condition used by the designated information search site. Then, an information search request based on this specific search condition is sent to the information search site. As a result, this information search site construes a content of the specific search condition and executes the information search based on this search condition. Therefore, the user is able to obtain a cross-search result exhibiting a high accuracy simply by once designating the search condition without being aware of the description rule for the search condition used by the information search site as the information search requestee and by giving the information search request to one or some information search sites arbitrarily designated among the plurality of information search sites with the scripts prepared beforehand corresponding thereto.

According to the present invention, the description for the search condition is a rule about, for example, names of parameters contained in the search condition, logic operators (such as a connector of “OR” and “AND”, parentheses for indicating a priority of the logic operation, negation, wild cards, etc.) for showing a relationship between values of the parameters, and so on, which defines characters or character strings used as these parameter names and as the logic operators and categories of the available logic operators. Accordingly, the conversion functions defined in the script include a function indicating that the character string of the parameter name used in the predetermined description rule is replaced with other character string, a function indicating that characters or a character string of the logic operator used in the predetermined description rule are or is converted into other characters or other character string, a function indicating that the parameter values are separated from each other, which are connected by the connector used in the predetermined description rule, a function indicating that elements after the connector onward are deleted if the parameter values are connected by the connector used in the predetermined description rule, and so forth.

According to the present invention, the search result received from the information search site may undergo information processing and thereafter be displayed to the user. In this case, it is sufficient if the script corresponding to the information search site as a sender of the search result defines the function for converting the search result. A content of the conversion is, if the search result is, e.g., HTML (HyperText Markup Language) data, a change of tags, addition of JavaScript (a trademark or registered trademark of Sun Microsystems Corp., in U.S.A. and in other countries) for making Browser execute a process of extracting a specified character string contained in the HTML data and displaying this character string in highlight, an addition or deletion of TARGET within an ANCHOR tag, a deletion of HREF within the ANCHOR tag, a change of URL within the ANCHOR tag, a change of ACTION within a FRAME tag, a change of URL within the FRAME tag, a change of URL within an AREA tag, and so forth.

### BRIEF DESCRIPTION OF THE DRAWINGS

The invention will be described below in details with reference to the accompanying drawings, in which:

FIG. 1 is a block diagram showing a cross-search system by way of one embodiment of the present invention;

FIG. 2 is a flowchart showing processes by a cross-search CGI program;

FIG. 3 is a flowchart showing processes by the cross-search CGI program;

FIG. 4 is a view showing a search item input screen; and

FIG. 5 is a view showing a search result display screen.

### DESCRIPTION OF THE PREFERRED EMBODIMENT

An embodiment of the present invention will hereinafter be described with reference to the accompanying drawings.

<System Architecture>

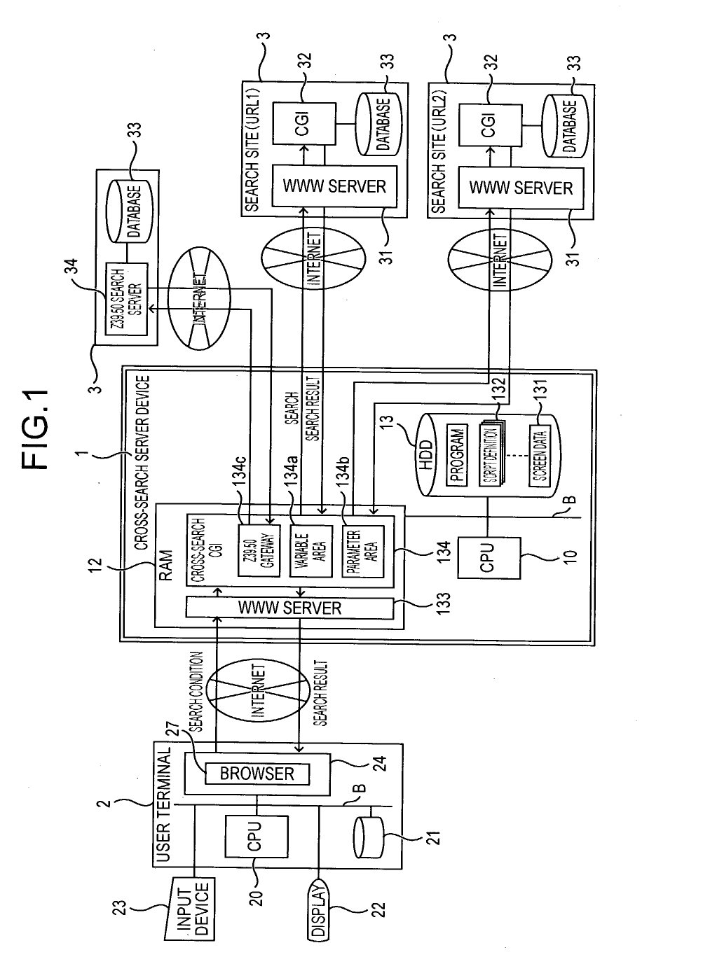

FIG. 1 is a block diagram showing an outline of architecture of a cross-search system according to the present embodiment. As illustrated in FIG. 1, this cross-search system is configured of a single cross-search server device 1, a user terminal 2 accessible to this cross-search server 1 via the Internet, and a search site 3 with which the cross-search server 1 can communicate through socket communications via the Internet.

Each search site 3 is defined in a broad sense as a server computer including a WWW server program 31, a search target database 33, a disk device stored with a search CGI (Common Gateway Interface) program 32 for searching the database 33, and a CPU for executing respective programs, or a server computer including the search target database 33, a disk device stored with a Z39.50 search server program for searching the database 33, and the CPU for executing the respective programs. The search site 3 is also defined in a narrow sense as each CGI program 32 or the Z39.50 search server program 34. Each search site 3 is based on a different description rule for available (interpretable) search conditions. The search condition description rule given herein is a rule about names of parameters contained in the search conditions, logic operators that represent relationships between values of the parameters and so on. This description rule defines contents of characters or of character strings used as names of these parameters and as the logic operators, and also defines categories of the available logic operators.

There actually exist a plurality of user terminals 2, though only one terminal 2 is illustrated in FIG. 1. Namely, a concept of the user terminal 2 includes all types of computers each connectable to the Internet and having a Web browse function. Each of the user terminals 2 is constructed of a CPU (Central Processing Unit) 20, a communication adapter (not shown), a display 22, an input device 23, a RAM (Random Access Memory) 24 and a disk device 21, which are connected to each other via a bus B. Among these components, the CPU 20 is the central processing unit for controlling the whole of the user terminal 2. Further, the communication adapter is a device serving as an interface with lines configuring the Internet N, and is specifically a MODEM, a TA (Terminal Adapter), a router etc. The display 22 is a display device for displaying images generated by the CPU 20. The input device 23 is a keyboard or a mouse. The RAM 24 is a main storage device on which an operation area is developed when the CPU 20 executes a variety of programs. The disk device 21 is stored with the variety of programs read onto the RAM 24 and executed by the CPU 20. The programs stored on this disk device 21 include a basic program containing a function that performs communications based on TCP/IP (Transmission Control Protocol/Internet Protocol) with the cross-search server device 1 via the communication adapter, and a Browser 27 for sending various messages to the cross-search server device 1 by utilizing the communication function of this basic program, and interpreting and displaying Web contents (HTML data etc) transmitted by the cross-search server device 1 in accordance with those messages. The Browser 27 is a Browser program that is generally commercially available, such as Internet Explorer (trademark of Microsoft Corp., U.S.A.) of Microsoft Corp., and hence a detailed explanation of the processing content thereof is herein omitted.

The cross-search server device 1 is a computer used as an Internet server device and is constructed of a CPU 10, a communication adapter (unillustrated), a RAM 12 and a hard disk 13 that are connected to each other via the bus B. Among these components, the CPU 10 is the central processing unit for controlling the whole of the cross-search server device 1. Further, the RAM 12 is a main storage device on which an operation area is developed when the CPU 10 executes a variety of processes. Moreover, the communication adapter is a communication device serving as an interface with lines (that is, an Internet backbone as the case may be) configuring the Internet N.

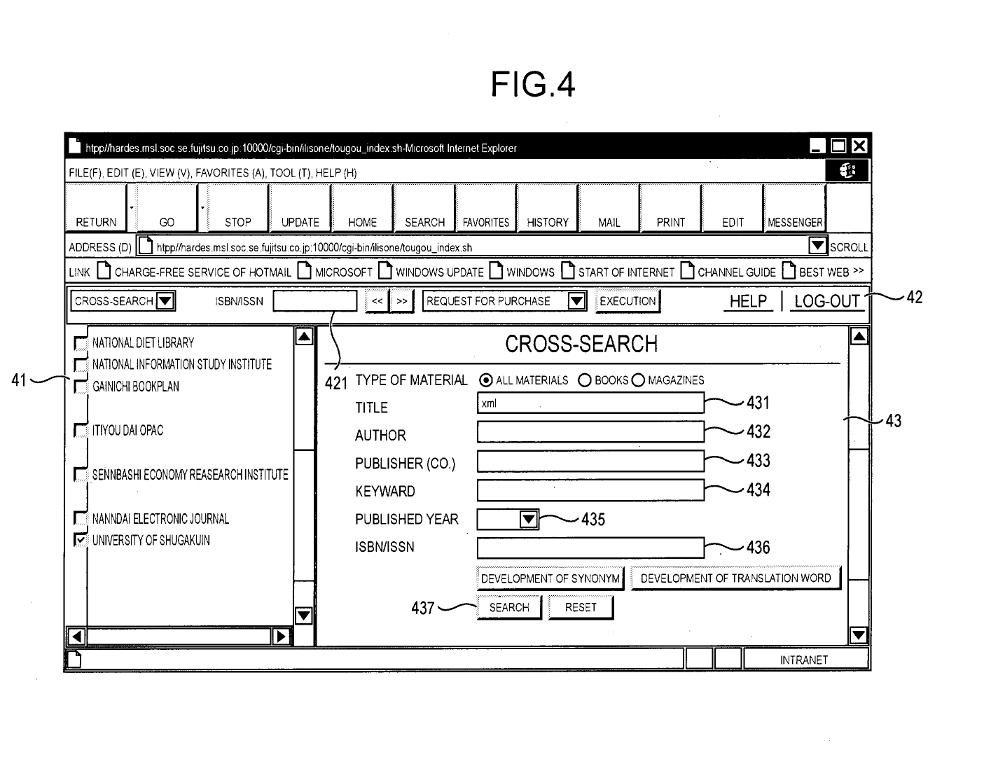

The hard disk 13 is a storage device stored with a variety of programs and various pieces of data read onto the RAM 12 and executed by the CPU 10. The data stored on the hard disk 13 contain screen data 131 (HTML data etc) for having various categories of screens (such as a search item input screen shown in FIG. 4) displayed by the Browser 27 and, in addition, the same number of script definitions 132 as the number of the search sites 3.

Specific contents of the script definitions 132 will be discussed in depth later on, however, each script definition 132 is a script file prepared before hand for every search site 3 and defines a group of functions executed by a cross-search CGI program 134 that will be explained later on. The group of functions defined by the script definitions 132 has such a content that search condition (that is an argument after “?” onward in URL (Uniform Resource Locator) addressed to the cross-search CGI program 134 which will hereinafter be described), based on the description rule, consisting of a name of item (that is a value given by “name=” included in an <INPUT></INPUT> tag set which will hereinafter simply be termed an <INPUT> tag) set in each of search item boxes on a search item input screen shown in FIG. 4 and of a value inputted in each of the search item boxes by a user (who is an operator of the user terminal 2), is converted into a specific search condition based on the description rule for a search condition available (interpretable) by each search site 3 (precisely to the search CGI program 32 or Z39.50 search server 34 of the site 3, which will hereinafter be explained), then a search request is given to the search site 3 (precisely to the search CGI program 32 or Z39.50 search server 34) by designating that search condition, and the search result received from the search site 3 as a result thereof is converted.

Further, the variety of programs stored on the hard disk 13 include, in addition to the OS that supports the TCP/IP protocol, a WWW server program 133 for reading from the hard disk 13 the screen data 131 specified by a URL requested in an HTTP (HyperText Transfer Protocol) request given from the Browser 27 to response it and for booting the CGI program specified by the requested URL, and also include the cross-search CGI program 134 categorized as one of the CGI programs.

This cross-search CGI program 134 (precisely the CPU 10 executing this program 134) executes a function (a CGI parameter conversion definition) described in the script definition 132 fits for the designated search site 3 based on the search condition specified in the URL given from the Browser 27 and obtained within a variable area 134a, thereby generating the search condition fits for this search site 3 in a parameter creation area 134b. Then, the cross-search CGI program 134 executes a function (a search execution definition)described in the same script definition 132, thereby generating and transmitting a search request (which is an HTTP request massage of a search request if the search site 3 is structured of the CGI program) addressed to the same search site 3 (precisely to the search CGI program 32 or Z39.50 search server 34 thereof) with the converted search condition used as the argument (wherein the above search request is transmitted through a Z39.50 gateway function 134c if the search site 3 is structured of the Z39.50 search server 34). The cross-search CGI program 134 performs a conversion by executing a function (an HTML conversion definition) described in the same script definition 132 with respect to the search result received from the search CGI program 32 of the same search site 3, further generates the screen data 131 of the search result display screen containing the converted search result, and responds to the Browser 27 as a request sender with the screen data. The Z39.50 gateway function 134 c contained in the cross-search CGI program 134 is a function of converting the search request addressed to the Z39.50 search server 34 into a bib1PRN query and sends this query to the server 34, and converting the search result received from the Z39.50 search server 34 into HTML data based on HTTP.

<Script Definition>

Specific contents of the script definitions 132 will hereinafter be described in details.

The script definition 132 is structured of a host definition for identifying the search site 3 using the same definition 132, and of a search script body for specifying a content of the search. Further, the search script body includes a CGI parameter conversion definition describing the group of functions executed for changing the search condition, a search execution definition (containing a URL definition of a destination party in communications) describing the group of functions executed for sending a search execution request message to the search site 3, and an HTML conversion definition describing the group of functions executed for changing the HTML data when receiving the same HTML data containing a result of the database search conducted by each search site 3. A meaning of the function definable in each script definition 132 will hereinafter be explained by giving its template.

To start with, functions (ADDPARAM, REPLACEOPER, REPLACEOPER2, DELOPERAND, SEPPARAM) related to the CGI parameter conversion definition, will be explained.

### ADDPARAM (NAME, VARIABLE)

This function indicates that a parameter name indicated by an argument: NAME and a value of the variable indicated by the argument: VARIABLE on the variable area 134a, are added to a tail of the parameter creation area 134b. In this case, the parameter name used by the search site 3 is set as the argument: NAME, and the item name in the search condition in the variable area 134a is set as the argument: VARIABLE. A returned value of the function becomes “0” in the case of a normal end, and becomes “−1” in the case of an abnormal end.

For example, if the search condition acquired on the variable area 134a by the cross-search CGI is “Title=HTML, Author=Fujitsu Taro”, and supposing that a function: ADDPARAM (term1, Title) and a function: ADDPARAM(term2, Author) are defined, the parameter creation area 134b after the conversion becomes “term1=HTML & term2=Fujitsu Taro”.

Note that an administrator of the database server can arbitrarily define the argument in the function in accordance with the specifications of the cross-search CGI. For instance, if the search condition acquired on the variable area 134a by the cross-search CGI is “key1=HTML, key2=Fujitsu Taro”, a function: ADDPARAM (term1, key1) and a function: ADDPARAM (term2, key2) may be defined in the script definition 132 fits for the search site 3 described above.

### REPLACEOPER (OPER, KEY, N)

This function indicates that a connector: + in VALUE of an N-th parameter: KEY on the CGI parameter creation area 134b is replaced with a designated character string: OPER. In this case, a character string (or etc) to be replaced is set as the argument: OPER, and a CGI parameter name on the parameter creation area 134b is set as the argument: KEY. A returned value of the function becomes “0” in the case of the normal end, becomes “1” if the connector: + does not exist, and becomes “−1” in the case of the abnormal end.

For example, if the search condition added onto the parameter creation area 134b by executing the above function: ADDPARAM is “term1=HTML+JavaScript”, and supposing that a function: REPLACEOPER (“or”, “term1”, 1) is defined, the parameter creation area 134b after the conversion becomes “term1=HTML or JavaScript”.

### REPLACEOPER2 (OPER, KEY, N)

This function indicates that a connector: “space” in VALUE of the N-th parameter: KEY on the CGI parameter creation area 134b is replaced with a designated connector: OPER. In this case, a character string (and etc) to be replaced is set as the argument: OPER, and a CGI parameter name on the parameter creation area 134b is set as the argument: KEY. A returned value of the function becomes “0” in the case of the normal end, becomes “1” if the connector “space” does not exist, and becomes “−1” in the case of the abnormal end.

For example, if the search condition added onto the parameter creation area 134b by executing the above function: ADDPARAM is “term1=C JavaScript”, and supposing that a function: REPLACEOPER2 (“and”, “term1”, 1) is defined, the parameter creation area 134b after the conversion becomes “term1=C and JavaScript”.

The searcher simply sets one pattern of search condition on the search condition input screen, whereby the three functions given above enable automatic generation of the plural patterns of search conditions defined by the parameter names respectively corresponding to the specifications of the search sites 3 for actually searching the database and by the connectors, which makes it possible to enhance an efficiency of searching.

### DELOPERAND (KEY, N)

This function indicates that if parameter values in VALUE of the N-th parameter: KEY on the CGI parameter creation area 134b are connected to each other by AND (+), elements after AND onward are deleted. In this case, a CGI parameter name on the parameter creation area 134b is set as the argument: KEY. A returned value of the function becomes “0” in the case of the normal end, and becomes “−1” in the case of the abnormal end.

For example, if the search condition added onto the parameter creation area 134b by executing the above function: ADDPARAM is “term1=C+++C language+JavaScript”, and supposing that a function: DELOPERAND (“term1”, 1) is defined, the parameter creation area 134b after the conversion becomes “term1=C++”.

### SEPPARAM (SEP, KEY, N, NUM, NAMES)

This function indicates that VALUE of the N-th parameter: KEY on the CGI parameter creation area 134b is delimited to parameter values connected by a connector: SEP, and a parameter name: NAMES is set in each of the parameter values. In this case, a connector (one character, +, etc.) for specifying the delimiter of the parameter values is set as the argument: SEP, and a CGI parameter name on the parameter creation area 134b is set as the argument: KEY. One or a plurality of CGI parameter names to be set in the respective delimited and separated parameter values are set as the arguments: NAMES, and the number of the CGI parameter names after being separated is set as the argument: NUM. A returned value of the function becomes “0” in the case of the normal end, and becomes “−1” in the case of the abnormal end.

For example, if the search condition added onto the parameter creation area 134b by executing the above function ADDPARAM is “term1=C+++C language+JavaScript”, and supposing that a function: SEPPARAM (+, “term1”,1,3,“term2”,“term3”)is defined, the parameter creation area 134b after the conversion becomes “term1=C++ & term2=C language & term3=JavaScript”.

The searcher simply sets one pattern of search condition on the search condition input screen, whereby the two functions given above enable the proper search condition to be sent also to the search sites unable to use a part of the logical expression (“and” or “or”) with the result that a cross-search result exhibiting a high accuracy can be obtained.

Next, functions (MAKEPARAM, GETHTTP, GETHTTPEX) related to the search execution definition will be explained.

### PRM=MAKEPARAM( )

This function indicates that the CGI parameter (the search condition) on the parameter creation area 134b is substituted into a variable: PRM.

### GETHTTP (URL, PARAM, METHOD)

This function indicates that HTML data corresponding to arguments: URL and PARAM are acquired by a transmitting method: METHOD. In this case, a URL address of the search CGI on the search site 3 that is defined by a URL of the destination party in communications is set as the argument: URL, a value (a CGI parameter) of the variable: PRM is set as the argument: PARAM, and a transmitting method (GET or POST) is set as the argument: METHOD. A returned value of the function is the obtained HTML data from the search site 3 and is a null character string in the case of the abnormal end.

### GETHTTPEX (URL, PARAM, METHOD, BASIC, COOKIE)

This function is one capable of designating whether Basic authentication is processed or not and whether Cookie is processed or not, in addition to the content of the function: GETHTTP described above. In this case, a distinction of whether the BASIC authentication is processed or not (“0” indicating no processing of BASIC, and “1” indicating an execution of processing of BASIC) is set as the argument: BASIC, and a distinction of whether Cookie is processed or not (“0” indicating no processing of Cookie, and “1” indicating an execution of processing of Cookie) is set as the argument: COOKIE. A returned value of the function is the HTML data itself in which the distinction of whether or not the processing of BASIC or Cookie is executed reflects in the case of the normal end, and is a null character string in the case of the abnormal end.

This scheme make it cope with a case where each of the search sites 3 is in the process of performing collation using COOKIE and the BASIC authentication as well.

NEXT, functions (ADDSTRING, ADDSTRINGLN, ADDANCORTGT, ADDANCORTGTEX, DELANCORTGT, DELANCORHREF, REPLACEANCOR, ADDCGITAG, REPLACEFRAME, REPLACEAREA) related to an HTML conversion definition, will be described.

### ADDSTRING (HTML, VALUE)

This function indicates that a character string: VALUE is added to a tail of the HTML data obtained. In this case, “HTML” is set as an argument: HTML, and the character string to be added is set as an argument: VALUE. A returned value of the function becomes “0” in the case of the normal end, and becomes “−1” in the case of the abnormal end.

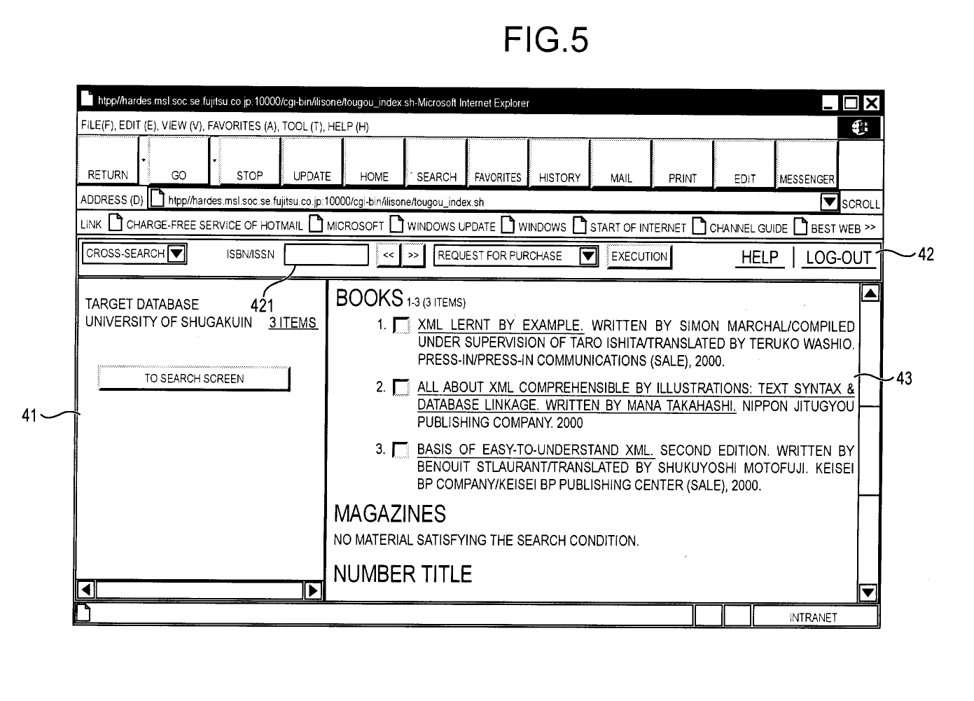

For instance, if the function: ADDSTRING (“HTML”,“parent.logo.document.logoform.ISBN#ISSN. value=”) is defined in the script definition 132, “parent.logo.document.logoform.ISBN#ISSN.value=” is added to a tail of the obtained HTML data. The added character string means that a value of ISBN and a value of ISSN each contained in the HTML data are displayed in an “ISBN/ISSN” box 421 on the search result display screen shown in FIG. 5.

With this scheme, a specified category of information can be taken out of the acquired HTML data and displayed in highlight in the search result display screen on the display 22 of the user terminal 2, thereby facilitating the acquisition of the information needed by the user.

### ADDSTRINGLN (HTML, VALUE)

This function indicate that a character string: VALUE and a line feed are added to the tail of the HTML data obtained. In this case, “HTML” is set as the argument: HTML, and the character string to be added is set as the argument: VALUE. A returned value of the function becomes “0” in the case of the normal end, and becomes “−1” in the case of the abnormal end.

This function also enables an acquisition of the same effect as that of the function: ADDSTRING described above.

### ADDANCORTGT (HTML, TARGET)

This function indicates that TARGET is added to all of <ANCHOR> tags in the obtained HTML data. If TARGET has already been specified, it is replaced with new TARGET. In this case, “HTML” is set as the argument: HTML, and a TARGET name to be added is set as an argument: TARGET. A returned value of the function becomes “0” in the case of the normal end, and becomes “−1” in the case of the abnormal end.

### ADDANCORTGTEX (HTML, URL, TARGET)

This function indicates that TARGET is added to all of <ANCHOR> tags containing an argument: URL in the obtained HTML data. If TARGET has already been specified, it is replaced with new TARGET. In this case, “HTML” is set as the argument: HTML, a URL corresponding to an element after “href=” onward within the <ANCHOR> tag is set as the argument: URL, and the TARGET name to be added is set as the argument: TARGET. A returned value of the function becomes “0” in the case of the normal end, and becomes “−1” in the case of the abnormal end.

With these two functions, specified TARGET can be automatically added to all the anchor tags within the HTML data obtained or to all the anchor tags containing the specified URL, and hence a search result that meets a purpose of the user can be displayed by changing an expression method as the user intends.

### DELANCORTGT (HTML, URL)

This function indicates a deletion of TARGET within the <ANCHOR> tag containing the URL getting coincident by a prefix search with the argument: URL in the obtained HTML data. In this case, “HTML” is set as the argument: HTML, and the URL corresponding to the element after “href=” onward within the <ANCHOR> tag is set as the argument: URL. A returned value of the function becomes “0” in the case of the normal end, and becomes “−1” in the case of the abnormal end.

With this function, TARGET of the anchor tag containing the specified URL within the obtained HTML data can be automatically deleted, and therefore a search result that meets a purpose of the user can be displayed by changing an expression method as the user intends.

### DELANCORREF (HTML, URL)

This function indicates a deletion of “href” within the <ANCHOR> tag containing the URL getting coincident by the prefix search with the argument: URL in the HTML data obtained. In this case, “HTML” is set as the argument: HTML, and the URL corresponding to the element after “href=” onward within the <ANCHOR> tag is set as the argument: URL. A returned value of the function becomes “0” in the case of the normal end, and becomes “−1” in the case of the abnormal end.

With this function, “href” within the <ANCHOR> tag containing the specified URL within the obtained HTML data can be automatically deleted, and hence a search result that meets a purpose of the user can be displayed by changing an expression method as the user intends.

### REPLACEANCOR (HTML, URL, NEWURL)

This function indicates that a URL within the <ANCHOR> tag, which is coincident with the argument: URL in the obtained HTML data is changed to NEWURL. In this case, “HTML” is set as the argument: HTML, the URL corresponding to the element after “href=” onward within the <ANCHOR> tag is set as the argument: URL, and a new URL to be replaced is set as an argument: NEWURL. A returned value of the function becomes “0” in the case of the normal end, and becomes ”−1” in the case of the abnormal end.

With this function, the specified URL within an <ANCHOR> tag in the obtained HTML data can be automatically changed, and therefore a search result that meets a purpose of the user can be displayed by changing an expression method as the user intends.

### ADDCGITAG (HTML, ACTION, NEWTAG, N)

This function indicates that an N-th <FORM> tag with ACTION in the obtained HTML data is changed to NEWTAG. In this case, “HTML” is set as the argument: HTML, “action” in a <FORM> tag is set as an argument: ACTION, a new tag to be replaced is set as an argument: NEWTAG, and a tag number (“0” in a case where all pieces of “action” become objects) of the <FORM> tag that should be changed in a case where HTML contains plural pieces of designated “action” is set as “N”. A returned value of the function becomes “0” in the case of the normal end, and becomes “−1” in the case of the abnormal end.

For example, if a function: ADDCGITAG (“HTML”, “/cgi-bin/astdb01.cgi”, “<INPUT TYPE=HIDDEN NAME=LANG value=J>,0”) is defined in the script definition 132, all <FORM> tags each having ACTION: “/cgi-bin/astdb01.cgi” contained in the obtained HTML data are changed to “<INPUT TYPE=HIDDEN NAME=LANG value=J>. As a result, the action originally described in the HTML data does not function on the Browser 27 on the user terminal 25.

With this function, the action within the specified <FORM> tag in the obtained HTML data can be automatically changed, and therefore a search result that meets a purpose of the user can be displayed by changing an expression method as the user intends.

### REPLACEFRAME (HTML, URL, NEWURL)

This function indicates that a URL within the <FRAME> tag, which is coincident with the argument: URL in the obtained HTML data is changed to NEWURL. In this case, “HTML” is set as the argument: HTML, the URL corresponding to the element after “href=” onward within the <FRAME> tag is set as the argument: URL, and a new URL to be replaced is set as an argument: NEWURL. A returned value of the function becomes “0” in the case of the normal end, and becomes “−1” in the case of the abnormal end.

With this function, the URL within the <FRAME> tag containing the specified URL in the obtained HTML data can be automatically changed, and therefore a search result that meets a purpose of the user can be displayed by changing an expression method as the user intends.

### REPLACEAREA (HTML, URL, NEWURL)

This function indicates that a URL within an <AREA> tag, which is coincident with the argument: URL in the obtained HTML data is changed to NEWURL. In this case, “HTML” is set as the argument: HTML, the URL corresponding to the element after “href=” onward within the <AREA> tag is set as the argument: URL, and a new URL to be replaced is set as the argument: NEWURL. A returned value of the function becomes “0” in the case of the normal end, and becomes “−1” in the case of the abnormal end.

With this function, the URL within the <AREA> tag containing the specified URL in the obtained HTML data can be automatically changed, and therefore a search result that meets a purpose of the user can be displayed by changing an expression method as the user intends.

Next, four specific examples of the script definition 132 will be exemplified.

### SPECIFIC EXAMPLE 1

Table 1 shows an example of the script definition 132 prepared when the search site 3 searches the database by using the search CGI program 32.

TABLE 1
[HOST]
$NAME = URL1
[SCRIPT]
#== VARIABLE DECLARATION ==#
STRINGCGI, HTML, PRM,VAR
INTEGER LEN,RET
#== CGI PARAMETER CONVERSION ==#
ADDPARAM(“SWD1”,keyword)
RET=SEPPARAM(” “,“SWD1”,1,2,“SWD2”,“SWD3”)
IF(RET=−1)

RET=SEPPARAM(“+”,“SWD1”,1,2,“SWD2”,“SWD3”)
IF(RET==1)

ADDPARAM(“SWD2”,””)
ADDPARAM(“SWD3”, ””)
ADDPARAM(“CNP2”,“AND”)
ADDPARAM(“CND3”,“AND”)

ELSE

ADDPARAM(“CND2”,“OR”)
VAR = GETNPARAM(“SWD3”,1)
IF(VAR==“”)

ADDPARAM(“CNP3”,“AND”)

ELSE

ADDPARAM(“CND3”,“OR”)

ENDIF

ENDIF

ELSE

ADDPARAM(“CND2”, “AND”)
ADDPARAM(“CND3”,“AND”)
VAR = GETNPARAM(“SWD3”,1)
IF(VAR==“”)

ADDPARAM(“SWD3”,“”)

ENDIF

ENDIF
#== SEARCH ==#
CGI =“http://unl1.ne.jp/cgi-bin/Search.cgi”
PRM = MAKEPARAM( )
HTML =GETHTTP(CGI, PRM, “POST”)
#==HTML CONVERSION ===#
ADDANCORTGT(“HTML”,“target=content”)
#== END ==#
EXIT( HTML )

Referring to Table 1, what is described under [HOST] is a host definition, and a description under [SCRIPT] constitutes a search script body. Further, in the search script body, a description defining a variable used when the cross-search CGI 134 executes a process based on this script definition 132, is appendixed with a comment: “VARIABLE DECLARATION”, functions related to the CGI parameter conversion definition are appendixed with a comment: “CGI PARAMETER CONVERSION”, functions related to the search execution are appendixed with a comment: “SEARCH”, and functions related to the HTML conversion definition are appendixed with a comment: “HTML CONVERSION”. Note that “IF( )” implies that if a condition defined within ( ) is met, a process described between itself and “ELSE” corresponding thereto is to be executed, and “ELSE” implies that the condition of “IF( )” corresponding thereto is not met, a process described between itself and “ENDIF” corresponding thereto is to be executed.

### SPECIFIC EXAMPLE 2

Table 2 shows an example of the script definition 132 prepared when the search site 3 searches the database by using the search CGI program 32.

TABLE 2
[HOST]
$NAME = URL2
[SCRIPT]
#== VARIABLE DECLARATION ==#
STRING CGI, HTML, PRM, STR,ISBN_ISSN₁₃ BEFORE,
ISBN_ISSN_AFTER
INTEGER RET,PLS,SIZE
STRING isbn
#== CGI PARAMETER CONVERSION ==#
ADDPARAM(“keyword”,keyword)
ADDPARAM(“keyword-andor”,“and”)
REPLACEOPER2(“AND”,“keyword”,1)
PEPLACEOPER(“OR”,“keyword”,1)
#== SEARCH ==#
CGJ = “http://url2.ac.jp/cgi-bin/opac/search”
PRM = MAKEPARAM( )
HTML = GETHTTP(CGI, PRM, “POST”)
#== HTML CONVERSION ==#
ADDPRESTR(“PRM”, “?”, PRM)
ADDPRESTR(“PRM”, CGI, PRM)
ADDPRESTR(“PRM”, PRM, “#book”)
REPLACEANCOR(“HTML”, “#book”, PRM)
#== END ==#
EXIT(HTML)

### SPECIFIC EXAMPLE 3

Table 3 shows an example of the script definition 132 prepared when the search site 3 searches the database by using the search CGI program 32.

TABLE 3
[HOST]
$NAME = URL3
[SCRIPT]
#== VARIABLE DECLARATION ==#
STRING CGI, HTML, PRM, ISBN, LOGIN, NEW_P
#== CGI PARAMETER CONVERSION ==#
ADDPARAM(“H”,H)
ADDPARAM(“C”,C)
ADDPARAM(“V”,V)
#== SEARCH ==#
CGI = “http://url3.co.jp/cgi-bin/db01.cgi”
PRM = MAKEPARAM( )
HTML = GETHTTP(CGI, PRM,“GET”)
#== HTML CONVERSION ==#
ADDCGITAG(“HTML”,“/cgi-bin/db01.cgi”,
“<INPUT TYPE=HIDDEN
NAME=LANG value=J>”,0)
REPLACEFORM(“HTML”,“/cgi-bin/db01.cgi”,
“<FORM METHOD=GET
ACTION=http://url5.co.jp/cgi-bin/search.cgi>”,0)
ADDANCORTGT(“HTML”, “target=_blank”)
DELANCORTGT(“HTML”,“/cgi-bin/db01.cgi”)
REPLACEANCOR(“HTML”,“/cgi-bin/astdh01.cgi”,
“http://url5.co.jp/cgi-bin/search.cgi”)
DELANCORHREF(“HTML”,“/cgi-bin/jump.cgi”)
DELANCORHREF(“HTML”,“#TOP”)
ISBN = GETSTRING(“HTML”,“>ISBN”, “”,1)
ADDSTRINGLN(“HTML”, “<SCRIPT language=JavaScript>”)
ADDSTRINGLN(“HTML”, “<!--”)
ADDSTRING(“HTML”,
“parent.logo.document.logoform.ISBN_ISSN.value=″”)
ADDSTRING(“HTML”,ISBN)
ADDSTRINGLN(“HTML”,“″;”)
ADDSTRINGLN(“HTML”,“//-->”)
ADDSTRINGLN(“HTML”,“</SCRIPT>”)
#== END ==#
EXIT(HTML)

TABLE 4
[HOST]
$UNIVNAME_J = z39.50
$UNIVNAME_E =
$UNIVNAME_C =
$UNIVNAME_H =
$CHARCODE = EUC
$HIT_PRE =
[SCRIPT]
#== VARIABLE DECLARATION ==#
STRINGCGI, HTML, PRM
#== CGI PARAMETER SETING ==#
ADDPARAM(“title”,title)
ADDPARAM(“auth”,auth)
ADDPARAM(“pub”,pub)
ADDPARAM(“keyword”,keyword)
ADDPARAM(“year”,year)
ADDPARAM(“isbnsn”,code)
#== SEARCH ==#
#== NOT EXIT BECAUSE OF NECESSITY OF CGI PARAMETER==#
PRM = MAKE PARAM( )

<Content of Processing>

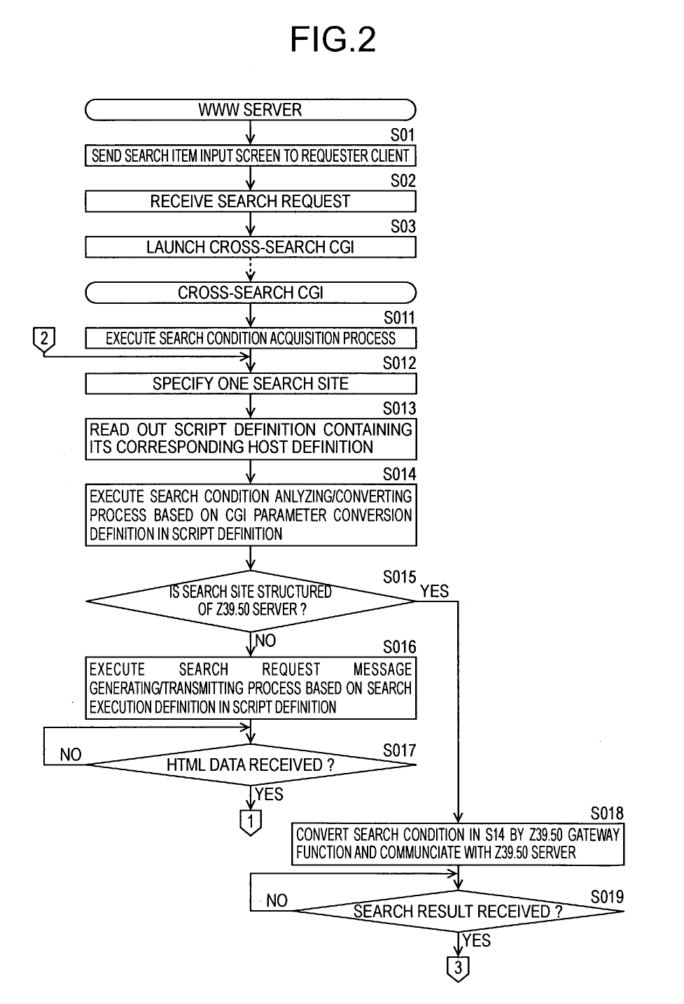

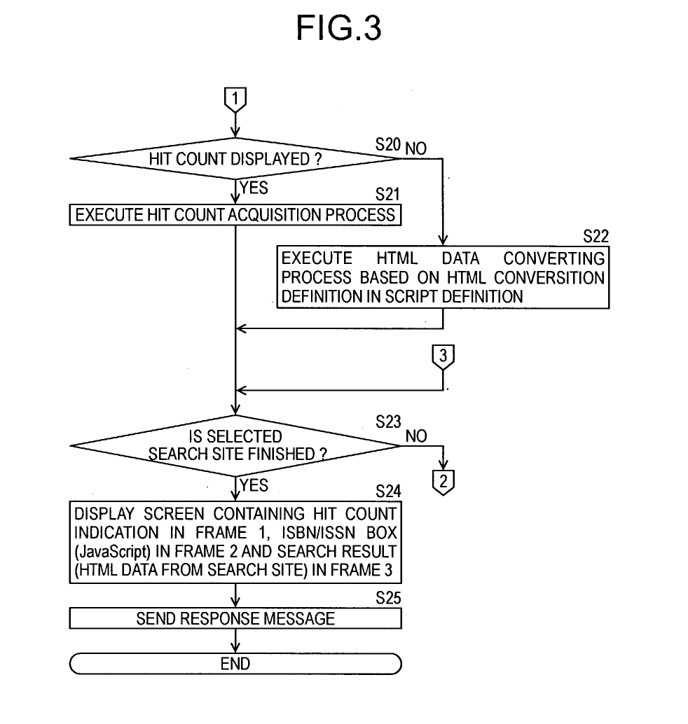

Next, a content of processing executed by the CPU 10 based on the cross-search CGI program 134 described above, will be explained referring to flowcharts in FIGS. 2 and 3.

Before the cross-search CGI program 134 is launched, when the Browser 27 on the user terminal 2 requests the WWW server 133 for the screen data of the search item input screen, the WWW server 133 sends the screen data as a response to the requester Browser 27 (S01). The Browser 27 receiving the screen data displays the search item input screen shown in FIG. 4 on the display 22.

This search item input screen is sectioned into a first frame 41 containing a multiplicity of check buttons allocated to the respective search sites 3, a second frame 42 containing an “ISBN/ISSN” box 421, and a third frame 43 containing a “title” box 431, an “author” box 432, a “publisher (co.)” box 433, a “keyword” box 434, a “published year” box 435, an “ISBN/ISSS” box 436 and a “search” button 437. In the HTML data contained in the screen data in order to display the contents of the third frame 43, an item name: “title” is set in the <INPUT> tag for displaying the “title” box 431, an item name: “auth” is set in the <INPUT> tag for displaying the “author” box 432, an item name: “pub” is set in the <INPUT> tag for displaying the “publisher (co.)” box 433, and an item name: “keyword” is set in the <INPUT> tag for displaying the “keyword” box 434. Further, an action that the arguments set in the boxes 431˜433 are transferred to the cross-search CGI program 134 with their item names through the method POST, is described in the form tag.

Accordingly, when the user (the operator of the user terminal 2) clicks the “search” button 437 with the input device 23 by pressing a click button or “enter” button with the cursor lapped on the button 437 on the search item input screen displayed on the display 22, a search request message in which the search conditions respectively consisting of combinations (item name=value) of the item names set in the boxes 431˜433 and the value inputted to the boxes 431˜433 serves as an argument is sent to the WWW server 133 (S02). Then, the WWW server 133 launches the cross-search CGI program 134 and transfers this search request message to the same program 134 (S03).

The cross-search CGI program 134 executes a search condition acquisition process in first step S11 after being launched. To be specific, the cross-search CGI program 134 acquires the arguments, i.e., the search conditions, contained in the search request message received from the WWW server program 133 in the variable area 134a (which corresponds to a search condition acquisition step). With this processing, the cross-search CGI program 134 recognizes search sites 3 selected with the check boxes allocated thereto in the frame 1 on the search item input screen marked.

In next step S12, the cross-search CGI program 134 specifies one search site 3 from the selected one search site 3 or the plurality of search sites 3 (which corresponds to an information search site specifying step).

In next step S13, the cross-search CGI program 134 reads from the hard disk 13 the script definition 132 containing the HOST definition for identifying the search site 3 specified in S12 (which corresponds to a script reading step), and executes the respective functions defined in this script definition 132 in accordance with the description in the script definition 132. Processes in subsequent steps S14 through 17 and S24 are processes based on this script definition 132.

In S14, the cross-search CGI program 134, based on the group of functions related to the CGI parameter conversion definition contained in the script definition 132, executes a search condition analyzing/converting process which is for converting the search conditions read in the variable area 134a and for generating a search condition based on the description rule available by the search site 3 in the parameter creation area 134b (which corresponds to a search condition converting step).

In next step S15, the processing diverts depending on whether the search site 3 is the Z39.50 server 34 or the destination party in the HTTP servers. The processing proceeds to S16 if the search site 3 is the destination party in the HTTP servers but diverts to S19 if the search site 3 is the Z39.50 server 34.

In S16, the cross-search CGI program 134 executes, based on the group of functions related to the search execution definition in the script definition 132, a search request message generating/transmitting process which is for generating and transmitting a search request addressed to the same search site 3 (the search CGI program 32) with the converted search condition serving as the argument (which corresponds to a search request step).

In next step S17, the cross-search CGI program 134 waits for HTML data containing the search result to be transmitted from the search site 3 (the search CGI program 32) in response to the search request sent in S16 (which corresponds to a search result receiving step). Then, upon receiving the same HTML data, the cross-search CGI program 134 checks in S20 whether or not the received HTML data contains a hit count and whether or not a hit count is to be displayed. Then, if the received HTML data contains the hit count and no CGI parameter is defined to avoid a hit count displaying process, in S21, the cross-search CGI program 134 extracts the hit count from the HTML data received in S17 to display it, and advances the processing to S23. Whereas if the received HTML data does not contain the hit count, or if a CGI parameter is defined to avoid the hit count displaying process, in S22, the cross-search CGI program 134 executes an HTML data converting process which is for converting the HTML data containing the search result (which corresponds to a search result converting step) on the basis of the group of functions related to the HTML conversion definition in the script definition 132. After a completion of S22, the cross-search CGI program 134 advances the processing to S23.

On the other hand, the cross-search CGI program 134 transmits in S18 the search request specifying the search condition in the parameter creation area 134b to the search site 3 (the Z39.50 server 34) through the Z39.50 gateway function 134c (which corresponds to a search request step). Then, in next step S19, the cross-search CGI program 134 waits for the search result to be sent in from the search site 3 (the Z39.50 server 34) in response to the search request sent in S18. Then, the cross-search CGI program 134 converts the search result into the HTML data in accordance with the search result received through the Z39.50 gateway function 134c, and advances the processing to S23.

In S23, the cross-search CGI program 134 checks whether or not the processes subsequent to S12 have been completed with respect to all the search sites 3 recognized in S11. Then, if these processes are not yet completed with respect to all the recognized search sites 3, the cross-search CGI program 134 makes the processing loop back to S12, wherein the cross-search CGI program 134 specifies the next search site 3. Whereas if the processes have been completed with respect to all the recognized search sites 3, the cross-search CGI program 134 advances the processing to S24.

In S24, the cross-search CGI program 134 generates the screen data for displaying the search result display screen containing the first frame 41 that indicates the name of the search site 3 and the hit count acquired in S21, the second frame 42 that indicates the “ISBN/ISSN” box 421, and the third frame that indicates the contents of the HTML data of the search result.

In step S25, the cross-search CGI program 134 sends a response message containing the screen data generated in S24 as a response to the Browser 27 on the requester user terminal 2 (which corresponds to a search result displaying step). The Browser 27 receiving the screen data displays, based on the screen data, the search result display screen as illustrated in FIG. 5.

According to the cross-search method and the cross-search program of the present invention having the configuration described above, once the user inputs the search condition in accordance with the predetermined method and specifies an information search site as an information search requestee, a search condition according to the description rule adopted by the information search site is automatically generated, and the user can request the information search site for the information search.

We claim:

1. A cross-search method of performing communications with a plurality of information search sites via a network, requesting each of said information search sites for an information search, and receiving a search result of the information search, said method comprising steps of:
preparing beforehand, for each of said information search sites, a script that defines functions for converting a predetermined description rule for a search condition into a description rule used by said information search site;
specifying said information search site designated by a user;
acquiring the search condition designated by the user on the basis of the predetermined description rule;
converting the search condition acquired in said search condition acquisition step into a search condition based on the description rule used by said information search site by executing the function defined in said script corresponding to said information search site specified in said information search site specifying step with respect to that search condition;
sending, to said information search site, an information search request based on the search condition converted in said search condition converting step;
receiving a search result of the information search conducted under the search condition by said information search site in response to the information search request; and
displaying the search result received in said search result receiving step to the user.

2. A cross-search method according to claim 1, wherein the description rule is related to parameter names used for the search condition, and
said script corresponding to each of said information search sites defines a function for changing the parameter name based on the predetermined description rule into a parameter name having synonymity, that is based on a description rule corresponding to each of said information search sites.

3. A cross-search method according to claim 1, wherein the description rule is related to connectors between the parameter names used for the search condition, and
said script corresponding to each of said information search sites defines a function for changing the connector based on the predetermined description rule into a connector having synonymity, that is based on a description rule corresponding to each of said information search sites.

4. A cross-search method according to claim 1, wherein said script defines a function for converting a content of the search result received from its corresponding information search site,
said method further comprising a search result converting step of converting the content of the search result to be displayed to the user in said displaying step by executing a function defined in said script corresponding to said information search site with respect to the search result received from said information search site in said search result receiving step.

5. A cross-search method according to claim 4, wherein the search result is HTML data, and
in said search result converting step, a tag within the search result is changed.

6. A cross-search method according to claim 5, wherein the search result is HTML data, and
in said search result converting step, an ANCHOR tag within the search result is changed.

7. A cross-search method according to claim 5, wherein the search result is HTML data, and
in said search result converting step, a FORM tag within the search result is changed.

8. A cross-search method according to claim 5, wherein the search result is HTML data, and
in said search result converting step, a FRAME tag within the search result is changed.

9. A cross-search method according to claim 5, wherein the search result is HTML data, and
in said search result converting step, an AREA tag within the search result is changed.

10. A cross-search method according to claim 4, wherein the search result is HTML data, and
in said search result converting step, a predetermined script is added to the search result.

11. A cross-search program for making a computer communicable with a plurality of information search sites via a network, execute:
a search condition acquisition step of acquiring a search condition designated by a user on the basis of a predetermined description rule;
an information search site specifying step of specifying said information search site designated by the user;
a script reading step of reading a script corresponding to said information search site specified in said information search site specifying step from plurality of scripts for said respective information sites each of which defines functions for converting the predetermined description rule for the search condition into a description rule used by said information search site;
a search condition converting step of converting the search condition acquired in said search condition acquisition step into a search condition based on the description rule used by said information search site by executing the function defined in said script read in said script reading step with respect to that search condition;
a search request sending step of sending, to said information search site, an information search request based on the search condition converted in said search condition converting step;
a search result receiving step of receiving a search result of the information search conducted under the search condition by said information search site in response to the information search request; and
a search result displaying step of displaying the search result received in said search result receiving step to the user.

12. A cross-search program according to claim 11, wherein said script further defines a function for converting a content of the search result received from its corresponding information search site, and
said program further making the computer execute a search result converting step of converting the content of the search result to be displayed to the user in said displaying step by executing a function defined in said script corresponding to said information search site with respect to the search result received from said information search site in said search result receiving step.
